(19) United States
(12) Patent Application Publication
(10) Pub. No.: US 2011/0022544 A1
(43) Pub. Date: Jan. 27, 2011

(54) SYSTEM AND METHOD FOR ISSUING MOBILE POSTAGE STAMP

(75) Inventors: Eun Hye KIM, Seoul (KR); Ki Hak KIM, Daejeon (KR); Dong Ho KIM, Daejeon (KR); Hoon JUNG, Daejeon (KR); Jong Heung PARK, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/843,141

(22) Filed: Jul. 26, 2010

(30) Foreign Application Priority Data
Jul. 24, 2009 (KR) 10-2009-0068033
Jun. 29, 2010 (KR) 10-2010-0062018

(51) Int. Cl. G07B 17/00

(52) U.S. Cl. 705/401

(57) ABSTRACT

In order to provide a mobile postage stamp, when mobile postage stamp application information is received from a terminal owned by a user, a mobile postage stamp providing system verifies a recipient mailing address included in the mobile postage stamp application information. After the verification of the recipient mailing address is completed, the mobile postage stamp providing system generates a serial number corresponding to the mobile postage stamp on the basis of the mobile postage stamp application information and provides the generated serial number to the terminal.

### CROSS-REFERENCE TO RELATED APPLICATION

This application claims priority to and the benefit of Korean Patent Application Nos. 10-2009-0068033 and 10-2010-0062018 filed in the Korean Intellectual Property Office on Jul. 24, 2009 and Jun. 29, 2010, the entire contents of which are incorporated herein by reference.

### BACKGROUND OF THE INVENTION

(a) Field of the Invention

The present invention relates to a system and method for issuing a mobile postage stamp in real time.

(b) Description of the Related Art

In general, in the field of a postal service, charges for postal matter are calculated after a corresponding postage stamp is adhered to the postal matter. In the case of parcel post, when the parcel post is received at a post office or when a person visits a post office and sends the parcel post, an additional invoice based on information on the weight, etc. of the postal matter is adhered to the postal matter, and postage rates for the postal matter are paid. In the case in which a large quantity of the postal matter is sent, a lot of time and effort is required in order to receive the postal matter at the post office. Accordingly, corresponding postage rates are paid in the form of extra payments or post payments in accordance with a contract between the post office and a service provider sending the postal matter.

In order to pay the postage rates as described above, there must be a procedure of receiving postal matter at a post office or a place where the postal matter will be sent. Accordingly, in order to solve the problem of the reception procedure, there is proposed a method of issuing a postage stamp in Internet environments.

It is, however, difficult to access a postal service over the Internet anywhere and anytime as in the case in which a user is moving. Further, there is a problem in that a postage stamp issued over the Internet is printed and adhered to postal matter and the postal matter has to be received.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for issuing a mobile postage stamp in real time, having an advantage of allowing a user to use a postal service anywhere and anytime using a mobile device.

An exemplary embodiment of the present invention provides a system for providing a mobile postage stamp, comprising an information management unit for managing service application information and mobile postage stamp application information received from any one of a terminal owned by a user or information collection means and managing information on a mobile postage stamp provided to the user; a mailing address verification unit for verifying a recipient mailing address included in the mobile postage stamp application information and outputting a result of the verification; and a mobile postage stamp generation unit for generating a serial number, corresponding to the mobile postage stamp, to be provided to the user using the mobile postage stamp application information based on the result of the verification output by the mailing address verification unit.

Another exemplary embodiment of the present invention provides a method of a mobile postage stamp providing system providing a mobile postage stamp, the method comprising

receiving mobile postage stamp application information from a terminal owned by a user; verifying a recipient mailing address included in the received mobile postage stamp application information; after the verification of the recipient mailing address is completed, generating a serial number corresponding to a mobile postage stamp based on the mobile postage stamp application information; and providing the generated serial number to the terminal.

### BRIEF DESCRIPTION OF THE DRAWINGS

FIG. 1 is a diagram illustrating an environment in which a mobile postage stamp issue system according to an exemplary embodiment of the present invention;

FIG. 2 is a block diagram showing a configuration of the mobile postage stamp issue system according to an embodiment of the present invention;

FIG. 3 is a flowchart illustrating a process of issuing a mobile postage stamp according to an exemplary embodiment of the present invention;

FIG. 4 is a flowchart illustrating a procedure of verifying a mobile postage stamp according to an exemplary embodiment of the present invention; and

FIG. 5 is a diagram illustrating a mobile postage stamp according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising”, will be understood to imply the inclusion of stated elements but not the exclusion of any other elements.

In the specification, a terminal may refer to a mobile station (MS), a mobile terminal (MT), a subscriber station (SS), a portable subscriber station (PSS), a user equipment (UE), or an access terminal (AT) and include some or all of the functions of the MS, the SS, the PSS, the UE, or the AT.

In the specification, a base station (BS) may refer to an access point (AP), a radio access station (RAS), a node B, a base transceiver station (BTS), or a mobile multihop relay (MMR)-BS and include or all of the functions of the AP, the RAS, the nodeB, the BTS, or the MMR-BS.

A mobile postage stamp system and a method of issuing and verifying postage stamps according to some exemplary embodiments of the present invention are described below with reference to the accompanying drawings.

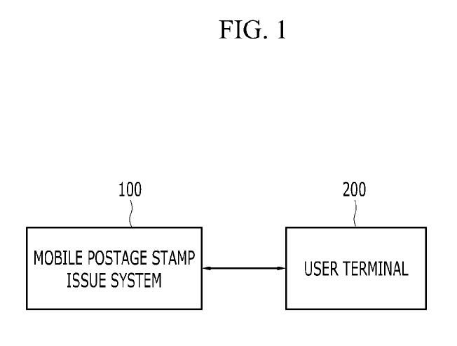

FIG. 1 is a diagram illustrating an environment in which a mobile postage stamp issue system according to an exemplary embodiment of the present invention.

As shown in FIG. 1, a user terminal 200 and a mobile postage stamp issue system 100 operate in conjunction with each other. In an exemplary embodiment of the present invention, for example, a mobile terminal is described as the user terminal 200. The mobile postage stamp issue system 100 is assumed to be included in information collection means operated by a postal service provider or a home-delivery provider, but not necessarily limited thereto.

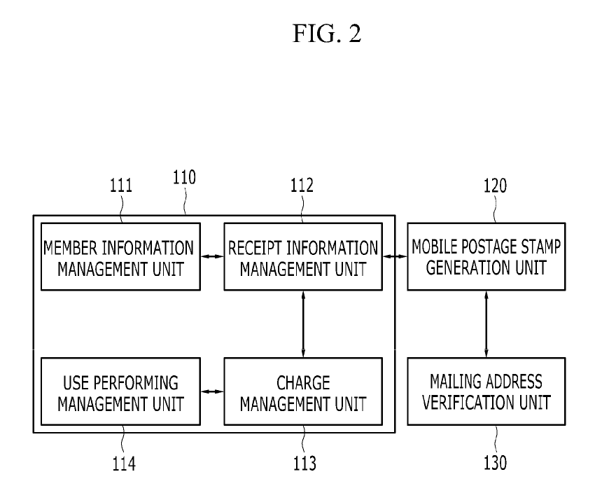

In such an environment, the system for issuing a mobile postage stamp to a user is described below with reference to FIG. 2.

FIG. 2 is a block diagram showing a configuration of the mobile postage stamp issue system 100 according to an embodiment of the present invention.

As shown in FIG. 2, the mobile postage stamp issue system 100 includes an information management unit 110, a mobile postage stamp generation unit 120, and a mailing address verification unit 130. The information management unit 110 includes a member information management unit 111, a receipt information management unit 112, a charge management unit 113, and a use performing management unit 114.

The information management unit 110 is first described below. The member information management unit 111 manages service application information applied for by a user who wants to use a mobile postage stamp service through information collection means, such as a web page, which is operated by a postal service provider or a home-delivery provider. Here, the service application information includes basic information, such as the name of a user who applies for the mobile postage stamp service, the mailing address of the user, and the subscriber number of a mobile terminal used by the user. That is, the service application information refers to information which is acquired when the user becomes a member and it is gathered in order to prevent the illegal use of a mobile postage stamp and to manage a user's record of performance.

The receipt information management unit 112 receives and parses information on a mobile postage stamp application which is sent by the user who applies for the mobile postage stamp service using a contact address, such as the main number of a postal service provider or a home-delivery provider, using information input means such as the user's mobile terminal. The mobile postage stamp application information includes the name of the user who applies for the mobile postage stamp, a user terminal subscriber number, the name of a recipient, and the mailing address of the recipient.

In an exemplary embodiment of the present invention, the receipt information management unit 112 is illustrated to receive the mobile postage stamp application information in the form of short message service (SMS) from the user terminal 200, but not necessarily limited thereto. Further, it is illustrated that the user sends the mobile postage stamp application information using his own mobile terminal, but the user may send the mobile postage stamp application information using information input means such as a personal computer (PC).

Further, the receipt information management unit 112 receives a serial number, corresponding to the mobile postage stamp generated by the mobile postage stamp generation unit 120 when the user makes an application for the mobile postage stamp, and sends the received serial number to the user terminal 200 on the basis of the information on the user terminal subscriber number included in the mobile postage stamp application information.

Further, the receipt information management unit 112 receives the mailing address of a recipient, included in the service application information managed by the member information management unit 111, and transfers the received mailing address to the mailing address verification unit 130. Further, the receipt information management unit 112 receives information indicating verification completion or a verification failure from the mailing address verification unit 130. If the verification is completed, the receipt information management unit 112 requests the mobile postage stamp generation unit 120 to generate the serial number for the verified mailing address and at the same time manages the mailing address.

However, if the verification failure information is received from the mailing address verification unit 130, the receipt information management unit 112 provides the user terminal 200 with information, indicating that the verification has failed, so that the user is aware of the verification failure. Here, in an exemplary embodiment of the present invention, a method of verifying a mailing address by checking a postal code and comparing the checked postal code and a postal code stored in a list of postal codes is used as the method of verifying the mailing address, but not necessarily limited thereto. Through such verification of the mailing address, not only return postal matter, but costs for processing return postal matter can be reduced.

The charge management unit 113 calculates a fee to be levied on a user who has used a mobile postage stamp service and manages information on fee payment. The fee payment information can include a user name, a fee to be paid by a corresponding user, a payment method, and so on. Further, in an exemplary embodiment of the present invention, a method of paying a mobile phone bill, including fee information on the use of the mobile postage stamp, is used as the method of paying the fee for the use of the mobile postage stamp, but not necessarily limited thereto.

The use performing management unit 114 stores and manages the mobile postage stamp application information, received from the receipt information management unit 112, and the serial number generated by the mobile postage stamp generation unit 120 so that they have a one-to-one correspondence relationship. That is, the use performing management unit 114 receives the mobile postage stamp application information of the user and pieces of information, such as the serial number generated by the mobile postage stamp generation unit 120 in response to the receipt of the mobile postage stamp application information and a date when the serial number was generated, from the receipt information management unit 112 and the mobile postage stamp generation unit 120, respectively, and manages the received mobile postage stamp application information and the received information.

Further, when the serial number inputted by a receptionist of postal matter is received, the use performing management unit 114 performs a mobile postage stamp verification procedure of determining whether the received serial number has already been stored and of checking the available period of the received serial number. To this end, in an exemplary embodiment of the present invention, for example, corresponding information can be managed for a certain period of time and then discarded when the corresponding period expires, but not necessarily limited thereto.

Accordingly, the use performing information managed by the use performing management unit 114 includes a user name, a serial number and an available period if a mobile postage stamp has been issued, and error count information for a corresponding user. The error count is increased by one if a user uses a serial number whose available period has expired or if a user does not use a mobile postage stamp in accordance with a lawful method, such as that a serial number once used is used again. The error count information is used to give warning to a user of the user terminal 200 if the error count is greater than a predetermined number of times.

The mobile postage stamp generation unit 120 generates a unique serial number for the user who applies for the mobile postage stamp on the basis of the mobile postage stamp application information managed by the receipt information management unit 112. Further, the mobile postage stamp generation unit 120 sends the generated serial number, together with information on a date when the serial number was generated, to the receipt information management unit 112. In a method of the mobile postage stamp generation unit 120 generating the serial number on the basis of the mobile postage stamp application information, the serial number can be randomly generated on the basis of the mobile postage stamp application information or can be generated using a predetermined generation algorithm. However, the exemplary embodiment of the present invention is not limited to any one of the methods.

Before the mobile postage stamp generation unit 120 generates the serial number corresponding to the mobile postage stamp, the mailing address verification unit 130 receives the parsed mobile postage stamp application information from the receipt information management unit 112. Next, the mailing address verification unit 130 checks whether the mailing address of the recipient included in the mobile postage stamp application information is an accurately written mailing address.

If, as a result of the check, the mailing address is an accurately written mailing address, the mailing address verification unit 130 sends verification success information, informing that the verification of the mailing address has been completed, to the receipt information management unit 112 so that the mobile postage stamp generation unit 120 can generate the serial number. However, if, as a result of the check, the mailing address is not an accurately written mailing address, the mailing address verification unit 130 sends verification failure information to the receipt information management unit 112 so that the corresponding information is displayed on the user terminal 200.

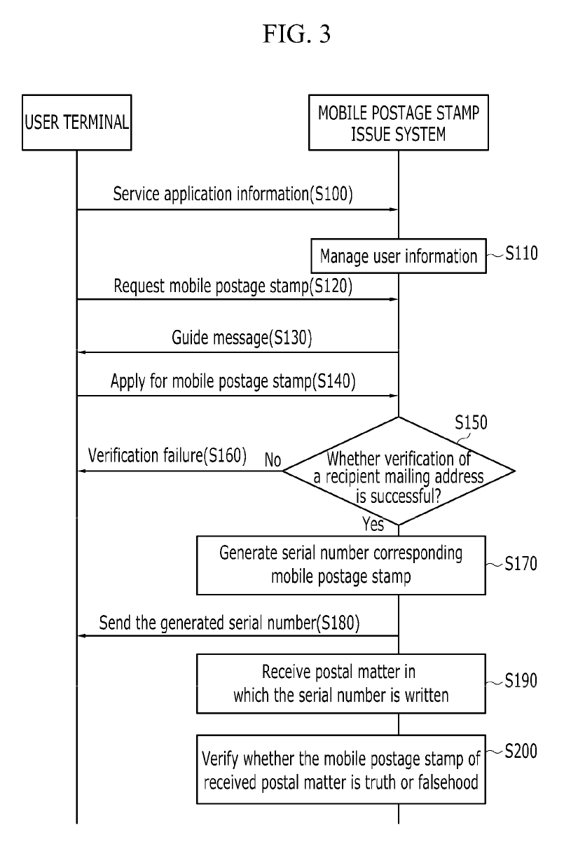

A method of issuing a mobile postage stamp using the mobile postage stamp issue system 100 including the above elements is described below with reference to FIG. 3.

FIG. 3 is a flowchart illustrating a process of issuing a mobile postage stamp according to an exemplary embodiment of the present invention.

Referring to FIG. 3, in accordance with an exemplary embodiment of the present invention, in order to provide a mobile postage stamp service requested by a user, the mobile postage stamp issue system 100 receives service application information inputted by the user through information collection means at step S100. If the user has already become a member or does not want to become a member, the service member subscription procedure of the step S100 can be omitted. The service application information (e.g., a user name, the mailing address of the user, and a terminal subscriber number) gathered during the service member subscription procedure is managed by the member information management unit 111 at step S110.

The user sends information on a request for a mobile postage stamp (hereinafter referred to as ‘mobile postage stamp request information’), indicating an application for the mobile postage stamp, to a postal service provider or a home-delivery provider using the user terminal 200 such as his own mobile phone at step S120. Here, a case in which the mobile postage stamp request information is sent to the main number of the postal service provider or the home-delivery provider in the form of SMS is described as an example. Further, the mobile postage stamp request information includes only information, informing that the user applies for the mobile postage stamp.

When the mobile postage stamp request information is received from the user, the mobile postage stamp issue system 100 sends a guidance message, including information on a fee for the mobile postage stamp and information on the use of the mobile postage stamp, to the user at step S130. Here, the guidance message further includes information on a method of paying the fee, along with the fee information. The guidance message further includes information and a format that must be written by the user in order to receive a serial number corresponding to the mobile postage stamp.

In accordance with the guidance message received at step S130, the user sends mobile postage stamp application information, including information on a user name, a terminal subscriber number, the mailing address of a recipient, and the name of the recipient, etc., to the mobile postage stamp issue system 100 at step S140. The receipt information management unit 112 of the mobile postage stamp issue system 100 transfers the mailing address of the recipient, included in the mobile postage stamp application information received at step S140, to the mailing address verification unit 130. Next, the mailing address verification unit 130 verifies the mailing address of the recipient at step S150.

If, as a result of the verification at step S150, the mailing address verification unit 130 fails to verify the mailing address of the recipient, the receipt information management unit 112 sends information, informing that the mailing address of the recipient is wrong, to the user terminal 200 so that the user is aware of the verification failure.

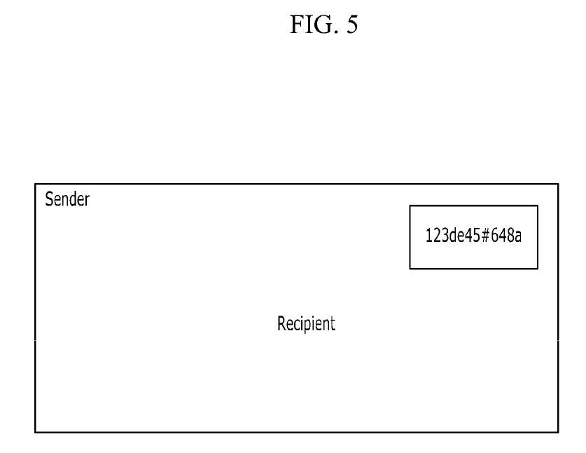

However, if, as a result of the verification at step S150, the mailing address verification unit 130 is successful in verifying the mailing address of the recipient, the receipt information management unit 112 requests the mobile postage stamp generation unit 120 to generate a serial number for the mobile postage stamp. The mobile postage stamp generation unit 120 generates the serial number on the basis of the mobile postage stamp application information at step S170 and sends the generated serial number to the user terminal 200 through the receipt information management unit 112 at step S180. When the user writes the received serial number in the stamp place of a mailing envelope, postal matter in which the serial number is written is received at a post office at step S190. An example of the mobile postage stamp written in the stamp place of a mailing envelope at step S190 is illustrated in FIG. 5.

FIG. 5 is a diagram illustrating a mobile postage stamp according to an exemplary embodiment of the present invention.

As shown in FIG. 5, in the exemplary embodiment of the present invention, the mobile postage stamp generated by the mobile postage stamp generation unit 120 is illustrated to have 12 digit codes, including numerals, the alphabet, and special symbols.

A serial number is used and received within 3 days after being generated in order to prevent the illegal use of the mobile postage stamp. Further, information on the serial number corresponding to the mobile postage stamp is managed in conjunction with information on an applicant's name, a terminal subscriber number, an application date, and a date of receipt so that it can be used to verify whether the mobile postage stamp is truth or falsehood.

In the exemplary embodiment of the present invention, a case in which a user who applies a mobile postage stamp directly writes a serial number in postal matter is described as an example. However, for example, in an environment in which an output device capable of outputting a serial number is included, a user may not directly write the serial number in postal matter. The present invention is not necessarily limited to the above case.

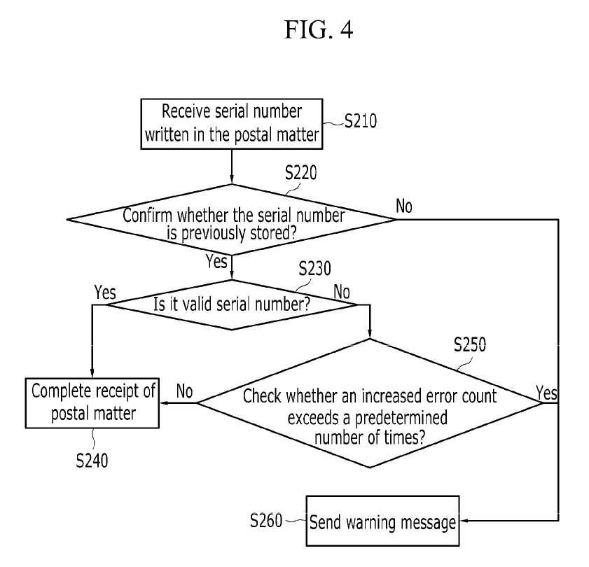

Referring back to FIG. 3, when the postal matter in which the serial number corresponding to the mobile postage stamp is written is received, the post office performs a sampling test for verifying the mobile postage stamp of the received postal matter is truth or falsehood at step S200. The sampling test refers to a test for arbitrarily selecting some of all pieces of postal matter received by date and determining whether a serial number is written in the selected postal matter or whether there is illegal use, such as the use of a serial number whose available period has expired. As described above, through the above procedure, the mobile postage stamp is issued, and the post office receives the postal matter using the issued mobile postage stamp and verifies whether the mobile postage stamp is truth or falsehood through the sampling test. A procedure of verifying whether a mobile postage stamp is truth or falsehood is described below with reference to FIG. 4.

FIG. 4 is a flowchart illustrating a procedure of verifying a mobile postage stamp according to an exemplary embodiment of the present invention.

Referring to FIG. 4, the use performing management unit 114 receives the serial number which has been written in the postal matter by a checker of the post office who accesses the mobile postage stamp issue system 100 at step S210. The use performing management unit 114 that has received the serial number confirms whether the serial number is stored in the mobile postage stamp generation unit 120 in which several mobile postage stamps are stored at step S220.

If, as a result of the confirmation, the received serial number is not stored in the mobile postage stamp generation unit 120, the use performing management unit 114 sends a warning message to the user terminal 200 for the corresponding postal matter at step S260. However, if, as a result of the confirmation, the received serial number is stored in the mobile postage stamp generation unit 120, the receipt information management unit 112 determines whether the received serial number is a valid serial number by checking the available period of the received serial number on the basis of a date when the received serial number was generated at step S230. If, as a result of the determination, the received serial number is a valid serial number, the receipt information management unit 112 informs the user terminal 200 that the receipt of the corresponding postal matter has been completed at step S240.

However, if, as a result of the determination, the received serial number is stored in the mobile postage stamp generation unit 120, but has an invalid period, the receipt information management unit 112 increases an error count by one. Next, the receipt information management unit 112 checks whether the increased error count is greater than a predetermined number of times at step S250.

If, as a result of the check, the increased error count is not greater than the predetermined number of times, information on the generation of the error is managed by the use performing management unit 114 and the receipt of the corresponding postal matter is completed at step S240. That is, in the case in which although a user has set postal matter received using a serial number having an expired period, the number of times that the user has used an invalid serial number is the first since the user has become a service member, the mobile postage stamp issue system 100 determines that the corresponding user has mistakenly used the serial number having an expired period and accepts the receipt of the postal matter. If, as a result of the check, the increased error count is greater than the predetermined number of times, the receipt information management unit 112 sends a warning message to the user terminal 200 at step S260.

Information on a mobile postage stamp generated using the above method is generated in real time when a user requests the mobile postage stamp. Accordingly, a user can use a postal service at the time when the user is unable to visit a post office or at the place where the user is unable to access the post office. Further, a unique serial number having an available period is generated and used. Accordingly, an illegal use of a mobile postage stamp can be prevented, and a receipt office, such as a post office or a logistics center, can verify whether a mobile postage stamp is truth or falsehood. Consequently, a user who uses a mobile postage stamp can easily issue the mobile postage stamp and easily set postal matter received. Further, a service provider, such as a postal service provider and a home-delivery provider, can easily calculate a fee and verify truth or falsehood.

In accordance with the exemplary embodiments of the present invention, user convenience can be provided because a postal service can be provided in real time on the basis of information on a postage stamp issued through a mobile device.

Furthermore, a postal matter reception office can verify whether a mobile postage stamp is truth or falsehood and verify the mailing address of a recipient when issuing a mobile postage stamp. Accordingly, return postal matter and the costs of processed postal matter can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for providing a mobile postage stamp, comprising:
an information management unit for managing service application information and mobile postage stamp application information received from any one of a terminal owned by a user or information collection means and managing information on a mobile postage stamp provided to the user;
a mailing address verification unit for verifying a recipient mailing address included in the mobile postage stamp application information and outputting a result of the verification; and
a mobile postage stamp generation unit for generating a serial number, corresponding to the mobile postage stamp, to be provided to the user using the mobile postage stamp application information based on the result of the verification output from the mailing address verification unit.

2. The system of claim 1, wherein the information management unit comprises:
a receipt information management unit for managing the received mobile postage stamp application information, providing the serial number of the mobile postage stamp to the terminal, and requesting the mobile postage stamp generation unit to generate the mobile postage stamp based on the result of the verification output from the mailing address verification unit or providing a verification failure message to the user;
a use performing management unit for managing the mobile postage stamp application information and the serial number received from the receipt information management unit and the mobile postage stamp generation unit, respectively, and verifying whether the mobile postage stamp is truth or falsehood; and
a charge management unit for calculating a fee to be levied on the user and managing fee payment information.

3. The system of claim 2, further comprising a member information management unit for managing the service application information applied for by the user who wants to use a mobile postage stamp service.

4. The system of claim 3, wherein the service application information comprises information on at least one of a name of the user, a mailing address of the user, and a subscriber number of the terminal, and the mobile postage stamp application information comprises information on at least one of a name of the user, a subscriber number of the terminal, a name of a recipient, and a mailing address of the recipient.

5. The system of claim 1, wherein the serial number comprises numerals, an alphabet, and special symbols.

6. A method of a mobile postage stamp providing system providing a mobile postage stamp, the method comprising:
receiving mobile postage stamp application information from a terminal owned by a user;
verifying a recipient mailing address included in the received mobile postage stamp application information;
after the verification of the recipient mailing address is completed, generating a serial number corresponding to a mobile postage stamp based on the mobile postage stamp application information; and
providing the generated serial number to the terminal.

7. The method of claim 6, further comprising:
before receiving the mobile postage stamp application information,
receiving service application information through information collection means; and
sending a guidance message to a terminal which has sent the service application information.

8. The method of claim 7, wherein the guidance message comprises information on a fee for the mobile postage stamp, a method of paying the fee, and a format of the mobile postage stamp application information.

9. The method of claim 6, further comprising verifying whether a mobile postage stamp for a serial number is truth or falsehood for postal matter in which the serial number is written, after providing the generated serial number to the terminal.

10. The method of claim 9, wherein verifying whether the mobile postage stamp for the serial number is truth or falsehood comprises:
determining whether the serial number is a valid number;
if, as a result of the determination, the serial number is not the valid number, increasing an error count by one;
checking whether the increased error count is greater than a predetermined number of times; and
If, as a result of the check, the increased error count is not greater than the predetermined number of times, completing a receipt of the postal matter in which the serial number is written.

11. The method of claim 10, further comprising if, as a result of the check, the increased error count is greater than the predetermined number of times, sending a warning message to a user terminal to which the serial number has been provided.

12. The method of claim 10, wherein determining whether the serial number is the valid number comprises:
checking whether the serial number is previously stored; and
if, as a result of the check, the serial number is previously stored, checking whether an available period of the certain serial number has expired.
